(19) United States
(12) Patent Application Publication
(10) Pub. No.: US 2016/0338544 A1
(43) Pub. Date: Nov. 24, 2016

(54) Manually-operated tool

(71) Applicant: Mario Rossi, Silea (IT)

(72) Inventor: Mario Rossi, Silea (IT)

(21) Appl. No.: 15/112,488

(22) PCT Filed: Jan. 21, 2015
(86) PCT No.: PCT/IB2015/050471

§ 371 Date: Jul. 19, 2016

(30) Foreign Application Priority Data
Jan. 21, 2014 (IT) TV2014A000008

(51) Int. Cl. A47J 43/26

(52) U.S. Cl. CPC A47J 43/26

(57) ABSTRACT

A manually-operated tool includes two mobile jaws which are reciprocally hinged by a cross pin to form a compass opening beak, and two control handles which are reciprocally hinged to be compass-moveable to one another, and are each connected to a relevant jaw to allow the user to open and close the beak moving the two handles; the proximal end of the first handle being rigidly integral to a first jaw; the proximal end of the second handle being mechanically connected to the second jaw by an epicyclic gear train which is arranged coaxial to the cross pin, inside a cavity formed in the body of the second jaw.

### TECHNICAL FIELD

The present invention relates to a manually-operated tool.

In more detail, the present invention relates to a manually-operated tool for breaking the hard, woody pericarp of walnuts or other similar nuts, traditionally called nut cracker, to which the following disclosure will explicitly refer without however loosing in generality.

### BACKGROUND ART

As is known, the walnut is the inner part or endocarp of an indehiscent fruit or drupe that does not have a clear distinction between epicarp and mesocarp, and is instead internally provided with a hard, woody endocarp or pericarp, traditionally called “shell”, which is substantially egg-shaped and houses an eatable pulp or kernel therein.

The manually-operated tool most commonly used to break the shell or pericarp of walnuts, traditionally called nut cracker, consists of two oblong arms or claws made of metal material, which are arranged side by side and are hinged together at the respective proximal ends so as to rotate like a compass with respect to each other.

The two oblong arms or claws are also provided, close to the connection pin, with two reciprocally faced jaw-shaped portions, between which the walnut to be broken is usually placed; whereas the distal ends of the two oblong arms or claws are shaped so as to form the two handles of the tool on which the user's hand applies the force required to break the walnut.

In order to reduce the user's effort to be applied on the tool handles to break the walnut shell, in recent years there have been developed nut crackers with a pliers structure in which a first jaw is made in one piece with one of the two tool handles, whereas the second jaw is connected to the second handle by a ratchet mechanism which allows the torque applied to the second handle to be transmitted to the jaw in a selective and reduced manner.

A pliers nut cracker with ratchet mechanism is described in International Patent Application PCT WO97/02779.

Unfortunately, experimental tests have highlighted that the ratchets of the ratchet mechanism occasionally suffer from jamming, which can make using the pliers nut cracker difficult.

To overcome this drawback, the ratchet mechanism in the nut cracker according to PCT International Patent Application WO00/67625 was replaced by an epicyclic gear train in which rotation of the lateral planet-carrier disc is selectively stopped by an oscillating ratchet which is pivoted with a rocking movement on the jaw made in one piece with one of the two tool handles, and is capable of engaging a toothing specifically realized on the periphery of the planet-carrier disc.

Unfortunately, the mechanical stresses resulting from the use of the tool are almost entirely discharged on the small group of teeth of the planet-carrier disc on which the oscillating ratchet engages each time, and the impulsive mechanical stresses on the teeth may reach enough high values to cause the sudden breaking of the teeth of the planet-carrier disc on which the oscillating ratchet engages at the time. This breaking obviously impairs operation of the nut cracker.

### DISCLOSURE OF INVENTION

Aim of the present invention is to provide a pliers nut cracker with epicyclic gear train which is free from the above-mentioned drawbacks and is cost-effective to be manufactured.

In compliance with the above aims, according to the present invention there is provided a manually-operated tool as defined in claim 1 and preferably, though not necessarily, in any one of the claims dependent thereon.

### BRIEF DESCRIPTION OF THE DRAWINGS

The present invention will now be described with reference to the accompanying drawings, which show a non-limiting embodiment thereof, in which:

FIGS. 1 and 2 are two perspective views of a manually-operated tool for breaking stone fruits with woody mesocarp, realized according to the teachings of the present invention;

FIG. 3 is a side view of the FIG. 1 tool, with parts in section and parts removed for clarity;

FIG. 4 is a sectional view of the FIG. 3 tool, taken along section line A-A and with sectional parts removed for clarity;

FIG. 5 is instead an exploded perspective view, with parts removed for clarity, of the FIG. 1 tool; whereas

FIG. 6 is a perspective view, with parts in section and parts removed for clarity, of a second embodiment of the FIG. 1 manually-operated tool.

### BEST MODE FOR CARRYING OUT THE INVENTION

With reference to figures from 1 to 5, numeral 1 indicates, as a whole, a manually-operated tool which may be advantageously used to break the pericarp of walnuts or other similar indehiscent fruits.

Tool 1 basically consists of two reciprocally mobile jaws 2 and 3 which are arranged facing and substantially coplanar to each other, and are reciprocally hinged so as to form a compass-opening beak 4, inside which the walnut or other nuts to be broken can be placed; and of two oblong control handles 5 and 6, which extend one beside the other while remaining on the lying plane P of the mobile jaws 2 and 3, are reciprocally hinged so as to be mutually compass-moveable, and are each mechanically connected to a respective jaw 2, 3 so as to allow the user to open and close the beak 4 by moving the handles 5 and 6.

In more detail, the two mobile jaws 2 and 3 are preferably structured to embrace and grip a walnut or other nut to be broken until it breaks, and are reciprocally hinged by means of a cross pin 7 which extends coaxial to a reference axis R locally substantially perpendicular to the lying plane P of the mobile jaws 2 and 3, and which engages in pass-through manner the body of both jaws, so as to allow the two mobile jaws 2 and 3 to rotate like a compass with respect to each other around the axis R while remaining on the lying plane P.

As regards to the two control handles 5 and 6, the proximal end of handle 5 is made in one piece with jaw 2, or anyway fixed/connected to jaw 2 in a rigid manner. The proximal end of handle 6 is instead hinged to the proximal end of handle 5 by means of cross pin 7, and is mechanically connected to jaw 3 by an epicyclic gear train which is arranged coaxial to axis R, inside a substantially cylindrical cavity specifically formed in the body of jaw 3.

The proximal ends of the two control handles 5 and 6 are thus hinged together by means of cross pin 7, so that the two handles 5 and 6 may open and close like a compass by rotating with respect to each other around axis R, while remaining on the lying plane P of the mobile jaws 2 and 3.

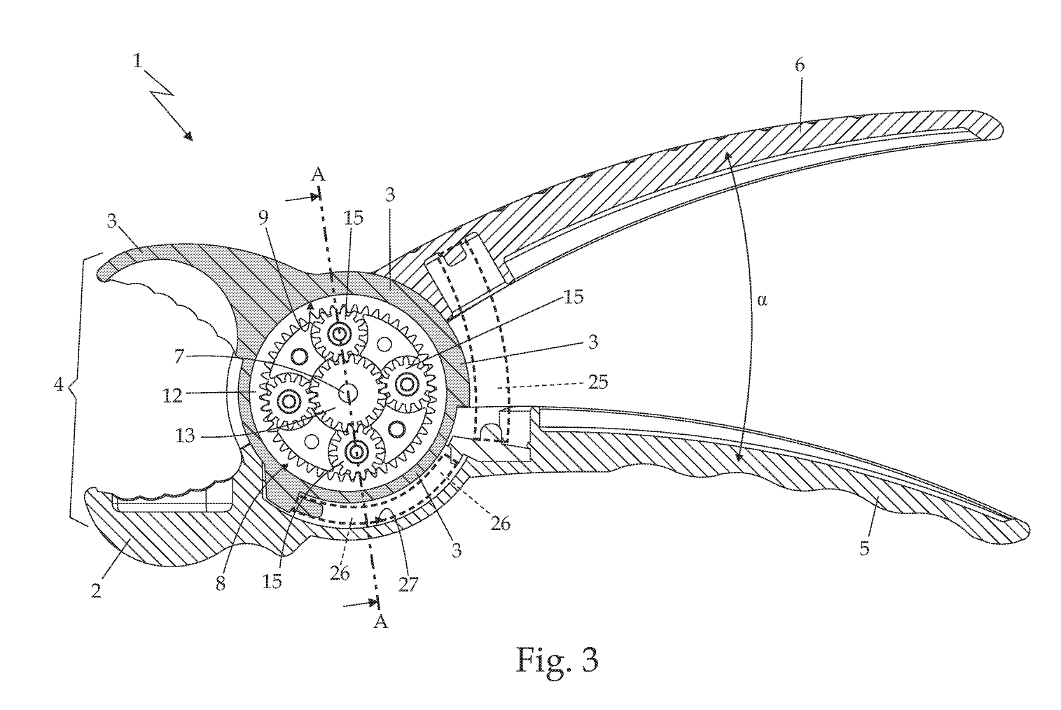

With reference to FIGS. 3, 4 and 5, in the example shown, in particular, jaw 3 is preferably provided with a pass-through hole 9 with a substantially circular section which extends substantially coaxial to axis R, and is structured so as to accommodate the epicyclic gear train 8. The epicyclic gear train 8 is moreover preferably fitted in axially rotatable manner on cross pin 7, inside the pass-through hole 9 of jaw 3.

The proximal end of handle 6 is instead preferably provided with two protruding discoidal winglets 10 which are arranged parallel and facing each other and coaxial to axis R, and are conveniently spaced apart from each other so as to surround the body of jaw 3 on opposite sides of the pass-through hole 9. The two discoidal winglets 10 of handle 6 are moreover conveniently dimensioned so as to substantially close/plug the two mouths of the pass-through hole 9, thus to close the ends of the substantially cylindrical cavity accommodating the epicyclic gear train 8.

Similarly to handle 6, the monolithic body or claw consisting of jaw 2 and handle 5 is preferably provided, at the proximal end of handle 5, with two protruding plate-shaped winglets 11 which cantilevered extend so as to be parallel and facing each other and perpendicular to axis R, each closely grazing a respective discoidal winglet 10 of handle 6 on the opposite side to the mouth of the pass-through hole 9, so as to surround the proximal end of handle 6 on opposite sides thereof, overlapping the two discoidal winglets 10.

Preferably, the two plate-shaped winglets 11 of handle 5 are also substantially discoidal in shape, are arranged so as to be substantially coaxial to axis R, and are conveniently dimensioned so as to completely cover the two discoidal winglets 10 of handle 6.

Cross pin 7 therefore extends coaxial to axis R while engaging in pass-through and axially rotatable manner, in sequence, a first plate-shaped winglet 11 of handle 5, the two discoidal winglets 10 of handle 6, and finally the second plate-shaped winglet 11 of handle 5, so as to connect together the two mobile jaws 2 and 3 and the two handles 5 and 6 in an axially rotatable manner.

Still with reference to FIGS. 3, 4 and 5, the epicyclic gear train 8 in turn comprises a toothed crown 12 preferably with straight teeth, which is arranged coaxial to axis R inside the pass-through hole 9 of jaw 3, preferably on the lying plane P of mobile jaws 2 and 3, and is locked/fitted in rigid manner on the body of jaw 3 so as to rotate around axis R only together with jaw 3; and a central pinion 13 which extends coaxial to axis R into the pass-through hole 9 and the toothed crown 12, is fitted on the cross pin 7 in an axially rotatable manner, and has its two axial ends fixed/locked in angularly rigid manner to the two discoidal winglets 10 of handle 6, so as to rotate around axis R only together with handle 6.

In the example shown, in particular, each of the two discoidal winglets 10 of handle 6 is provided with a central pass-through hole 14 which has a toothed section complementary to that of central pinion 13, so as to prevent central pinion 13 from rotating inside the central pass-through hole 14, and the central pinion 13 extends to bridge the two discoidal winglets 10 while engaging in pass-through manner the central pass-through holes of both discoidal winglets 10.

Finally, the epicyclic gear train 8 is also provided with a series of toothed planet wheels 15 (four in the example shown) which are located inside the pass-through hole 9 so as to be angularly spaced around axis R, are dimensioned so as to engage the toothed crown 12, and are finally fixed in an axially rotatable manner to a rotatable planet-carrier assembly 16 which, in turn, is fitted in axially rotatable manner on the central pinion 13, inside the pass-through hole 9 of jaw 3, with the capability of rotating freely around axis R independently of the central pinion 13.

In more detail, the toothed planet wheels 15 are preferably arranged inside the pass-through hole 9 so as to be locally substantially coplanar to the toothed crown 12, are preferably angularly equally spaced around axis R, and finally are preferably dimensioned so as to engage both the toothed crown 12 and the central pinion 13.

The rotating planet-carrier assembly 16, instead, is structured to be substantially in the shape of a cylindrical reel, and extends along the central segment of pinion 13 while remaining locally coaxial to axis R, so as to arrange the two heads 17 thereof, each behind the inner face of a respective discoidal winglet 10 of handle 6.

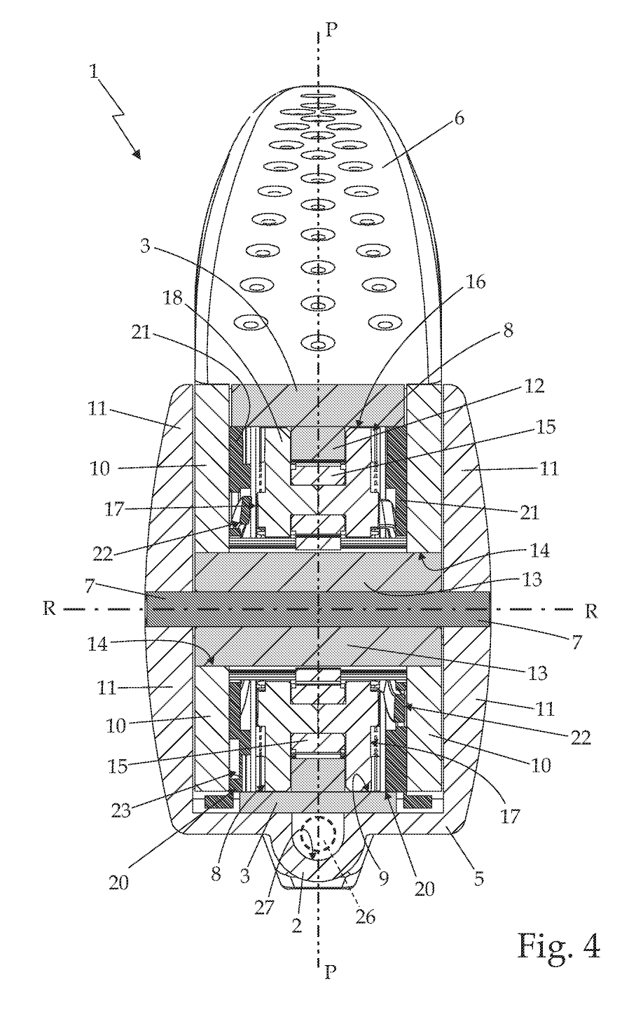

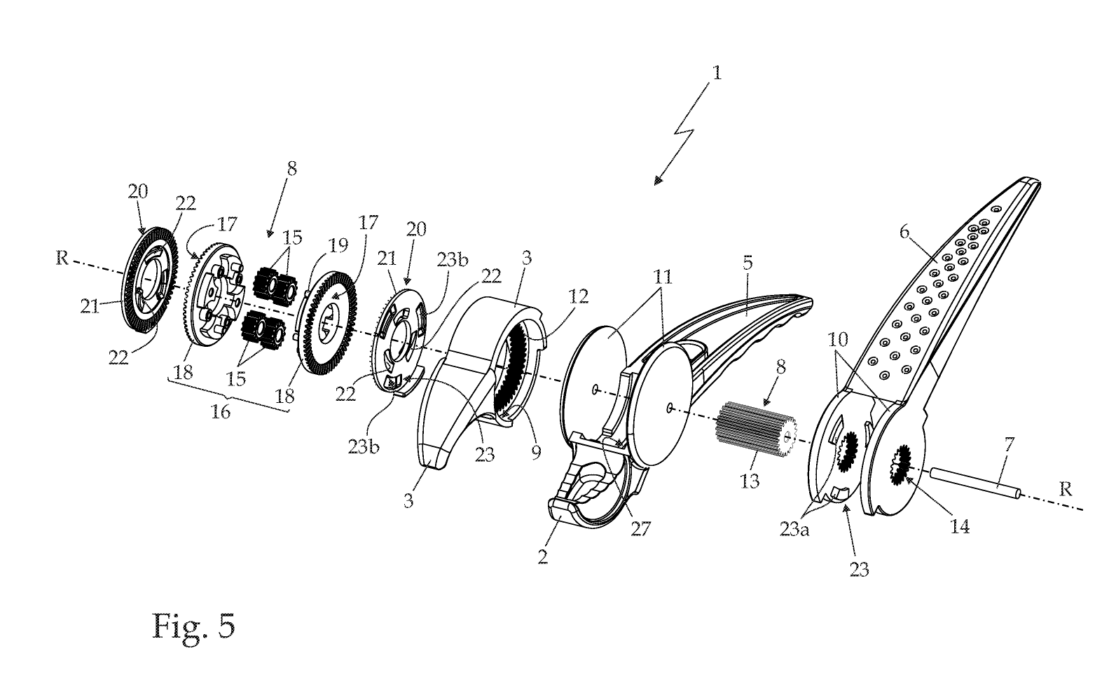

With reference to FIGS. 4 and 5, in the example shown, in particular, the planet-carrier assembly 16 is preferably divided into two complementary annular bodies 18, which are arranged coaxial to axis R in abutment against each other, and are dimensioned so as to be accommodated in axially rotatable manner inside the pass-through hole 9 of jaw 3, on opposite sides of the toothed crown 12, so as to trap in between themselves the toothed planet wheels 15 of the epicyclic gear train 8.

Therefore, each of the two annular bodies 18 faces a respective discoidal winglet 10 of handle 6, and defines a respective head 17 of the substantially cylindrical reel-shaped planet-carrier assembly 16.

Additionally, the two annular bodies 18 are also jointly structured so as to carry in axially rotatable manner the individual toothed planet wheels 15 of the epicyclic gear train 8.

In more detail, in the example shown each annular body is preferably provided with a series of cross pins 19 with circular section that cantilevered protrude toward the other annular body 18 while remaining substantially parallel to axis R, and are angularly spaced around axis R so that each cross pin 19 is locally aligned to a respective toothed wheel 15 of the epicyclic gear train 8.

Preferably each cross pin 19 furthermore extends parallel to axis R up to reach the corresponding circular-section cross pin 19 of the other annular body 18, so as to form a small support shaft parallel to axis R; and each toothed planet wheel 15 of the epicyclic gear train 8 is preferably fitted in axially rotatable manner on the support shaft made up by the two cross pins 19.

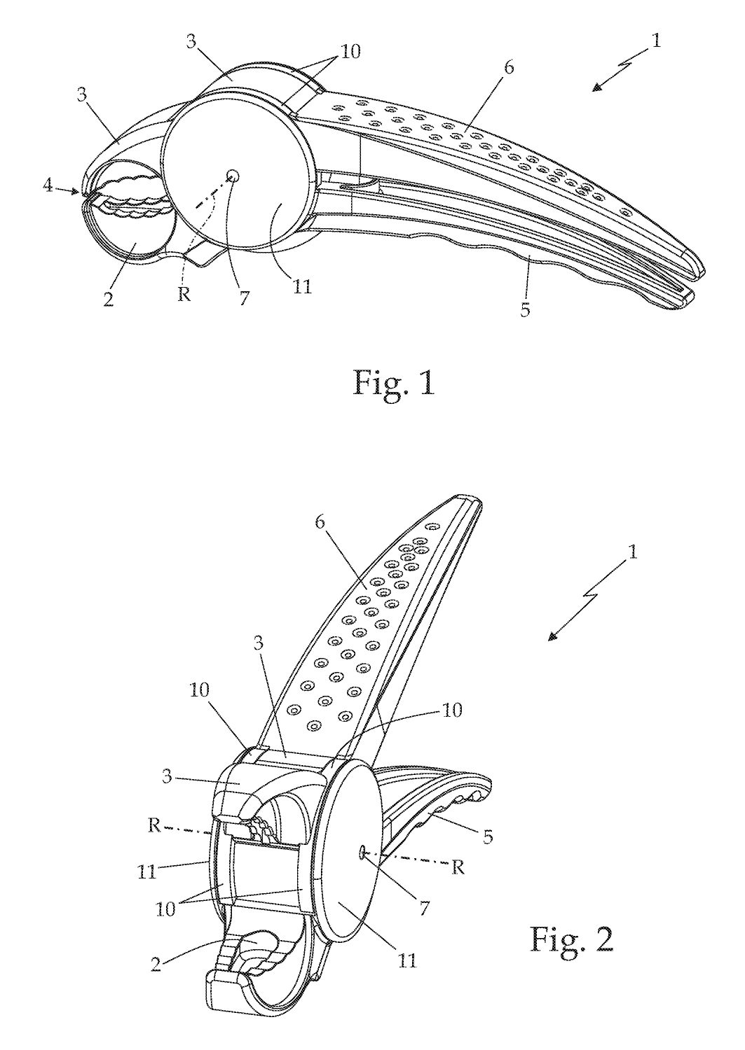

With reference to FIGS. 3, 4 and 5, the manually-operated tool 1 additionally comprises two automatic locking devices 20 which are located inside the pass-through hole 9 of jaw 3, on opposite sides of the planet-carrier assembly 16 of epicyclic gear train 8, so that each locking devices faces a respective head 17 of the planet-carrier assembly 16, and are structured to selectively lock/connect in synchronized manner the planet-carrier assembly 16 in rigid manner to the body of jaw 2 when the two handles 5 and 6 are closed/neared together (see FIG. 1) in order to tighten/close the two mobile jaws 2 and 3 against each other.

In more detail, the two automatic locking devices 20 are angularly integral with the body of jaw 2, and are structured to selectively abut against the annular heads 17 of the planet-carrier assembly 16 to prevent any rotation of the planet-carrier assembly 16 with respect to the body of jaw 2, when the two handles 5 and 6 are closed/neared together (see FIG. 1) in order to tighten/close the two mobile jaws 2 and 3 against each other.

In the example shown, in particular, the two automatic locking devices 20 are preferably structured so as to abut against the annular heads 17 of the planet-carrier assembly 16 to prevent any rotation of the planet-carrier assembly 16 with respect to the body of jaw 2, when the opening angle α between the two handles 5 and 6 is less than a predetermined threshold value preferably, though not necessarily, ranging from 5° to 25°.

With reference to FIGS. 3, 4 and 5, in the example shown, in particular, each automatic locking device 20 preferably comprises an annular clutch disc 21 which is fitted on the central pinion 13 substantially at the mouth of the pass-through hole 9 of jaw 3, with the capability to rotate freely around axis R inside the pass-through hole 9 and with the capability to move axially from and toward the planet-carrier assembly 16, and is structured so as to be coupled to the planet-carrier assembly 16 in angularly rigid manner when abutting against the annular head 17 of the same planet-carrier assembly 16. In addition, the clutch disc 21 is moreover structured so as to remain angularly integral with the body of jaw 2 regardless of its position inside the pass-through hole 9, so as to make the planet-carrier assembly 16 angularly integral with the body of jaw 2 when abutting against the annular head 17 of the planet-carrier assembly 16 itself.

With reference to FIGS. 4 and 5, each automatic locking device 20 preferably furthermore comprises an elastic member 22 which is preferably interposed between annular head 17 and clutch disc 21, and is structured so as to elastically push the clutch disc 21 away from the head 17 of the planet-carrier assembly 16.

Finally, each automatic locking device 20 is provided with a cam mechanism 23 which is located between the clutch disc 21 and handle 6, and is structured so as to push, when the opening angle α between the two handles 5 and 6 is lower than a predetermined value, the clutch disc 21 into abutment against the annular head 17 of the planet-carrier assembly 16 overcoming any elastic thrust of the elastic member 22.

In more detail, in the example shown the cam mechanism 23 is preferably located between the clutch disc 21 and the adjacent discoidal winglet 10 of handle 6, and is structured so as to push the clutch disc 21 into abutment against the head 17 of the planet-carrier assembly 16 when the discoidal winglet 10 of handle 6 is in a predetermined angular position with respect to the same clutch disc 21.

In the example shown, in particular, the cam mechanism 23 is structured to push the clutch disc 21 into abutment against the annular head 17 of the planet-carrier assembly 16 when the opening angle α between the two handles 5 and 6 is lower than a threshold value preferably, though not necessarily, ranging from 5° to 25°.

With reference to FIGS. 4 and 5, in the example shown, in particular, the clutch disc 21 preferably consists of a toothed ring plate 21 which is fitted on the central pinion 13 at the mouth of pass-through hole 9, with the capability to freely rotate around axis R inside the pass-through hole 9 and with the capability to move axially from and toward the planet-carrier assembly 16, so as to be able to engage, by means of its annular toothing, onto a corresponding annular toothing specifically formed on the annular head 17 of planet-carrier assembly 16, i.e. on the outer face of the annular body 18.

Preferably the toothed ring plate 21 is moreover provided with a protruding locking key which is structured to protrude from the pass-through hole 9 through a gap between the discoidal winglet 10 of handle 6 and the body of jaw 3, and to engage a seat specifically formed in the body of jaw 2, so as to cause the toothed ring plate 21 to rotate around axis R only together with the body of jaw 2.

The elastic member 22 instead is preferably fitted on the central pinion 13 substantially coaxial to axis R, and preferably, though not necessarily, consists of a series of flexible tabs 22 arranged in a crown and which cantilevered protrude from clutch disc 21, or better from the toothed ring plate 21, angularly equally spaced around the central pinion 13, and rest on the surface of the annular head 17 of the planet-carrier assembly 16 so as to elastically push the toothed ring plate 21 away from the planet-carrier assembly 16.

In the example shown, in particular, the flexible tabs 22 are preferably made in one piece with the toothed ring plate 21.

In other words, the elastic member 22 may be made in one piece with the clutch disc 21.

Obviously, in a different embodiment, the flexible tabs 22 may be replaced, for example, by a small cup-shaped or helical spring, or by a small ring made of elastomeric material, which is preferably fitted on the central pinion 13, between the annular head 17 and the toothed ring plate 21, i.e. the clutch disc 21.

With reference to FIGS. 4 and 5, in the example shown the cam mechanism 23 instead preferably comprises a series of protruding sliding elements 23a (three sliding elements in the example shown), preferably arched in shape, which protrude from the inner face of the discoidal winglet 10 of handle 6, preferably angularly equally spaced around axis R, and rest in freely sliding manner on the bottom of corresponding arch-shaped grooves 23b which have the centre of curvature on axis R and are specifically realized on the face of clutch disc 21, or better of the toothed ring plate 21, directly facing the discoidal winglet 10 of handle 6.

The arched grooves 23b have a ramp- or chute-shaped profile and are dimensioned so as to push/move the clutch disc 21, or better the toothed ring plate 21, into abutment against the annular head 17 of planet-carrier assembly 16 when the discoidal winglet 10 of handle 6 is in a predetermined angular position with respect to the clutch disc 21, or better with respect to the toothed ring plate 21, and to jaw 2.

In the example shown, in particular, the protruding sliding elements 23a and the arched grooves 23b of the cam mechanism 23 are preferably conveniently dimensioned so as to push the clutch disc 21, or better the toothed ring plate 21, into abutment against the annular head 17 of the planet-carrier assembly 16 when the opening angle α between the two handles 5 and 6 is lower than a threshold value preferably, though not necessarily, ranging from 5° to 25°.

With reference to FIGS. 3 and 4, the manually-operated tool 1 preferably furthermore comprises a second elastic member 25 which is interposed between the two handles 5 and 6, and is structured so as to elastically push the two handles 5 and 6 away from each other, so as to keep the two control handles 5 and 6 stably in a wide open configuration in which the opening angle α between the handles takes its maximum value (see FIGS. 2 and 3).

In more detail, the elastic member 25 is structured so as to elastically push the two handles 5 and 6 away from each other, so as to keep the two control handles 5 and 6 stably in a wide open configuration in which the opening angle α between the handles 5 and 6 (see FIGS. 2 and 3) is greater than the threshold value below which the two automatic locking devices 20 stop rotation of the planet-carrier assembly 16 with respect to the body of jaw 2.

In the example shown, in particular, the manually-operated tool 1 is preferably provided with a long conical spiral spring 25 which is preferably interposed between the two handles 5 and 6 preferably, though not necessarily, close to cross pin 7, and is structured to elastically push the two handles 5 and 6 away from each other, so as to keep the handles 5 and 6 stably in a wide open configuration in which the opening angle α between the handles 5 and 6 (see FIGS. 2 and 3) takes a value preferably, though not necessarily, ranging from 10° to 30°.

With reference to FIGS. 3, 4 and 5, preferably the manually-operated tool 1 finally also comprises a third elastic member 26 which is interposed between the two mobile jaws 2 and 3, and is structured so as to elastically push the mobile jaws 2 and 3 away from each other, so to keep the beak 4 in an open configuration (see FIGS. 2 and 3) which allows a walnut to be inserted between the mobile jaws 2 and 3.

In the example shown, in particular, the manually-operated tool 1 is preferably provided with a long helical spring 26 which is accommodated inside a longitudinal groove 27 which is specifically formed on the concave portion of the claw formed by jaw 2 and handle 5, which is laterally flanked by the two plate-shaped winglets 11 of handle 5 and is intended to house jaw 3. The longitudinal groove 27 preferably furthermore lies on the midplane of the claw formed by jaw 2 and handle 5, and is closed at the top by the body of jaw 3 so that the helical spring 26 is held inside the longitudinal groove 27 by the body of jaw 3.

Instead, the helical spring 26 is located inside the longitudinal groove 27 with its two ends in abutment one against the body of handle 5, and the other against an appendage of the body of jaw 3 protruding inside the longitudinal groove 27.

Operation of manually-operated tool 1 is easily inferable from the above description, and does not require further explanations, other than to specify that tool 1 may also be advantageously used to break the exoskeleton of a shellfish or to firmly grasp an object.

Additionally, one or both the mobile jaws 2 and 3 may be provided with a blade or cutting edge, so that tool 1 may be used as cutting nippers or other manually-operated cutting tool.

In other words, rather than being structured to embrace and grip a walnut or other nut to be broken until it brakes, one or both the mobile jaws 2 and 3 of tool 1 may be provided with a blade or cutting edge so as to cut like a shear or cutting nippers.

The advantages result from the presence of the two automatic locking devices 20 acting in a synchronized manner on the two heads 17 of the planet-carrier assembly 16 are large in number.

Firstly, the mechanical stresses related to using the tool are evenly distributed over the whole surface of the two heads 17 of the planet-carrier assembly 16, or better over all the teeth present on the two heads 17 of the planet-carrier assembly 16, thus zeroing the risks of breakage even in presence of stronger impulsive mechanical stress.

Furthermore, the particular operating mode of the two automatic locking devices 20 makes tool 1 easier to be operated.

Clearly changes and variants may be made to the above-described manually-operated tool 1 without, however, departing from the scope of the present invention.

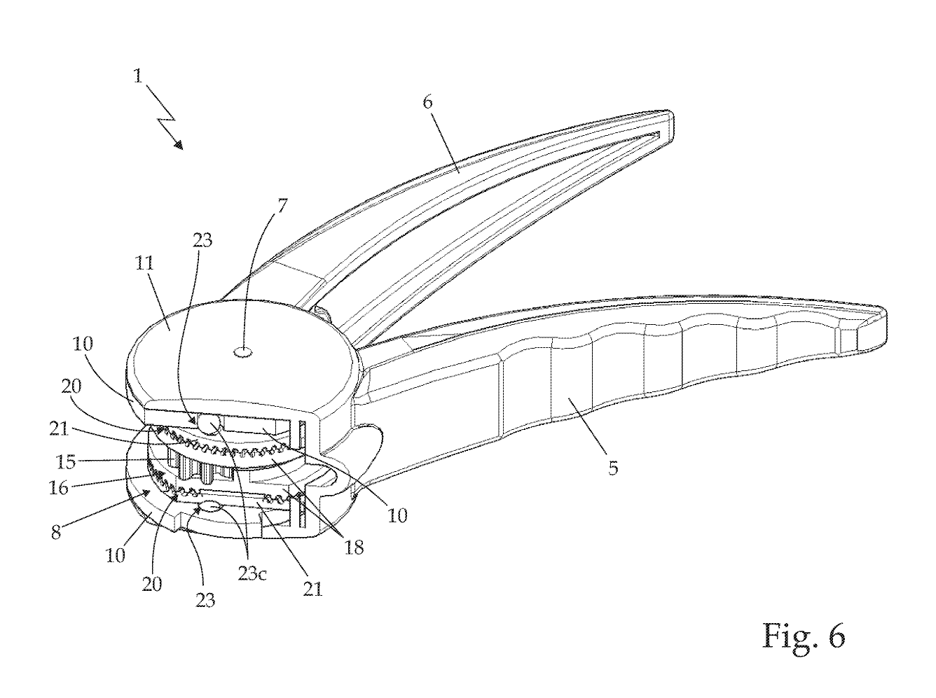

For example, with reference to FIG. 6, in place of the protruding sliding elements 23a and the ramp- or chute-shaped grooves 23b, the cam mechanism 23 may comprise a series of small balls 23c which are accommodated in freely rotatable manner inside specific seats realized on the inner face of the discoidal winglet 10 of handle 6, angularly equally spaced around axis R. Each ball 23c has a diameter such as to protrude from the seat on the discoidal winglet 10 and to rest on the bottom of an opposite groove with variable depth, specifically realized on the adjacent face of the clutch disc 21, or better of the toothed ring plate 21.

Also in this case, the variable depth grooves are arch-shaped with the centre of curvature on axis R, and the profile thereof is dimensioned so as to push/move the clutch disc 21 into abutment against the head 17 of the planet-carrier assembly 16 as the angular position of the discoidal winglet 10 varies.

Finally, in a not shown, simplified embodiment, the manually-operated tool 1 may be provided with a single automatic locking device 20 which is located inside the pass-through hole 9 of jaw 3, directly facing one of the two heads 17 of the planet-carrier assembly 16, and is structured so as to selectively lock/connect the planet-carrier assembly 16 in rigid manner to the body of jaw 2 when the handles 5 and 6 are closed/neared together (see FIG. 1) in order to tighten/close the two mobile jaws 2 and 3 against each other, with the purpose of breaking the shell of a walnut possibly interposed between the two jaws.

The invention claimed is:

1. A manually-operated tool (1) comprising,
first and second mobile jaws (2, 3) which are reciprocally hinged by a cross pin (7) to form a compass-opening beak (4); and
first and second control handles (5, 6) which are reciprocally hinged to be compass-moveable in relation to one another, and are each connected to a respective jaw (2, 3) to allow a user to open and close the beak (4) moving the two handles (5, 6);
a proximal end of the first handle (5) being rigidly integral to a first jaw (2);
a proximal end of the second handle (6) being mechanically connected to the second jaw (3) by an epicyclic gear train (8), which is arranged coaxial to said cross pin (7), inside a cavity (9) formed in a body of the second jaw (3);
the epicyclic gear train (8) comprising,
a central pinion (13), which extends inside the cavity (9) in the second jaw (3) substantially coaxial to the cross pin (7) and is angularly integral with the second handle (6), and
a rotatable planet-carrier assembly (16), which is fitted in axially rotatable manner on the central pinion (13), inside the cavity (9) in the second jaw (3) and is disposed to freely rotate around an axis (R) of the cross pin (7) independently of the central pinion (13); and
at least one automatic locking device (20), which is located inside the cavity (9) in the second jaw (3), directly facing one of two heads (17) of the planet-carrier assembly (16), and is structured to selectively lock/connect the planet-carrier assembly (16) in rigid manner to a body of the first jaw (2) when the two handles (5, 6) are closed/neared together to tighten/close the two jaws (2, 3) against each other.

2. The manually-operated tool according to claim 1, wherein said at least one automatic locking device (20) is angularly integral to the body of the first jaw (2), and is structured to selectively move against an opposite head (17) of the planet-carrier assembly (16) to prevent any rotation of the planet-carrier assembly (16) with respect to the body of the first jaw (2) when the two handles (5, 6) are closed/neared together to tighten/close the two jaws (2, 3) against each other.

3. The manually-operated tool according to claim 2, wherein said at least one automatic locking device (20) is structured to move against the head (17) of the planet-carrier assembly (16) to prevent any rotation of the planet-carrier assembly (16) with respect to the body of the first jaw (2) when an opening angle (a) between the two handles (5, 6) is less than a given limit value.

4. The manually-operated tool according to claim 3, wherein said at least one automatic locking device (20) comprises an annular clutch disc (21) which is fitted on the central pinion (13) inside the cavity (9) in the second aw (3) and is configured to rotate around the axis (R) of the cross pin (7) and to move axially to and from the planet-carrier assembly (16), is angularly integral to the body of the second aw (2), and is structured to couple in angularly rigid manner with the planet-carrier assembly (16) when the clutch disc abuts against the head (17) of the planet-carrier assembly (16).

5. The manually-operated tool according to claim 4, wherein said at least one automatic locking device (20) further comprises a cam mechanism (23) which is located between the clutch disc (21) and the second handle (6), and is structured to push, when the opening angle (a) between the two handles (5, 6) is less than a given value, the clutch disc (21) in abutment against the head (17) of the planet-carrier assembly (16).

6. The manually-operated tool according to claim 5, wherein the cam mechanism (23) is structured to push the clutch disc (21) against the head (17) of the planet-carrier assembly (16) when the opening angle (a) between the two handles (5, 6) is less than a limit value.

7. The manually-operated tool according to claim 5, wherein said at least one automatic locking device (20) also comprises a first elastic member (22) which is structured to elastically push the clutch disc (21) away from the head (17) of the planet-carrier assembly (16);
the cam mechanism (23) being structured to push the clutch disc (21) in abutment against the head (17) of the planet-carrier assembly (16) overcoming an elastic force of said elastic member (22).

8. The manually-operated tool according to claim 4, wherein the clutch disc (21) is a toothed ring plate (21) which is adapted to engage with its annular toothing on a corresponding annular toothing formed on the head (17) of the planet-carrier assembly (16).

9. The manually-operated tool according to claim 5,
wherein the second jaw (3) is provided with a pass-through hole (9) which extends substantially coaxially the axis (R) of the cross pin (7) and accommodates the epicycle gear train (8), and
wherein the proximal end of the second handle (6) is provided with two protruding discoidal winglets (10) which are parallel and facing each other and coaxial to the axis (R) of the cross pin (7), and are spaced so as to surround the body of the second jaw (3) on opposite sides of said pass-through hole (9);
said at least one automatic locking device (20) being located inside said pass-through hole (9), and the two discoidal winglets (10) of the second handle (6) being dimensioned to substantially close/plug two mouths of said pass-through hole (9).

10. The manually-operated tool according to claim 9, wherein the cam mechanism (23) of the automatic locking device (20) is located between the clutch disc (21) and adjacent discoidal winglet (10) of the second handle (6), and is structured to push the clutch disc (21) in abutment against the head (17) of the planet-carrier assembly (16) when the discoidal winglet (10) of the second handle (6) is arranged in a given angular position with respect to the clutch disc (21).

11. The manually-operated tool according to claim 10, wherein the cam mechanism (23) further comprises a series of sliding elements (23a) or balls (23c) which protrude from an internal face of the discoidal winglet (10) of the second handle (6), and rest in freely sliding manner on a bottom of corresponding grooves (23b) with ramp or chute profile and which are specifically formed on a face of the clutch disc (21).

12. The manually-operated tool according to claim 9, wherein the proximal end of the first handle (5) is provided with two protruding plate-shaped winglets (11) which cantilevered extend parallel and facing each other and perpendicular to the axis (R) of the cross pin (7), each glazing a respective discoidal winglet (10) of the second handle (6), so as to surround the proximal end of the second handle (6) from opposite sides on the proximal end.

13. The manually-operated tool according to claim 1, further comprising a second elastic member (25) which is interposed between the two handles (5, 6) and is structured to elastically push the two handles (5, 6) away from each other.

14. The manually-operated tool according to claim 1, further comprising a third elastic member (26) which is interposed between the two mobile jaws (2, 3) and is structured to elastically push the mobile jaws (2, 3) away from each other, thus to keep the beak (4) in an open configuration.

15. The manually-operated tool according to claim 1, further comprising two automatic locking devices (20) which are located inside the cavity (9) in the second jaw (3), on opposite sides of the planet-carrier assembly (16), so that each faces a respective head (17) of the planet-carrier assembly (16), and are structured to selectively lock/connect the planet-carrier assembly (16) in rigid manner to the body of the first jaw (2) when the two handles (5, 6) are closed/neared to each other to tighten/close the two mobile jaws (2, 3) against each other.
